(19) United States
(12) Patent Application Publication
(10) Pub. No.: US 2026/0023165 A1
(43) Pub. Date: Jan. 22, 2026

(54) MANAGING TIME OF FLIGHT INFORMATION IN A COHERENT DETECTION AND RANGING SYSTEM

(71) Applicant: Analog Photonics LLC, Boston, MA (US)

(72) Inventors: Benjamin Roy Moss, Cambridge, MA (US); Michael Robert Watts, Hingham, MA (US)

(73) Assignee: Analog Photonics LLC, Boston, MA (US)

(21) Appl. No.: 19/270,981

(22) Filed: Jul. 16, 2025

Related U.S. Application Data
(60) Provisional application No. 63/673,011, filed on Jul. 18, 2024.

(51) Int. Cl. G01S 7/481; G01S 7/4911; G01S 7/4915

(52) U.S. Cl. CPC G01S 7/4817; G01S 7/4818; G01S 7/4911; G01S 7/4915

(57) ABSTRACT

An apparatus comprises: a transmitter module comprising: a first optical beam steering module, and timing circuitry configured to control timing of steering of the first optical beam steering module; and a receiver module comprising: a second optical beam steering module, and timing circuitry configured to control timing of steering of the second optical beam steering module; wherein timing of the steering of the first optical beam steering module and second optical beam steering module are controlled to include a delay based at least in part on a predetermined maximum target range.

### CROSS-REFERENCE TO RELATED APPLICATION(S)

This application claims the benefit of and priority to U.S. Provisional Application Ser. No. 63/673,011, entitled “MANAGING TIME OF FLIGHT INFORMATION IN A COHERENT DETECTION AND RANGING SYSTEM,” filed Jul. 18, 2024, which is incorporated herein by reference.

### STATEMENT AS TO FEDERALLY SPONSORED RESEARCH

This invention was made with government support under the following contract: Army Research Lab via the National Center for Manufacturing Sciences Collaboration Agreement 2022134-142232. The government has certain rights in the invention.

### TECHNICAL FIELD

This disclosure relates to managing time of flight information in a coherent detection and ranging system.

### BACKGROUND

Some detection and ranging (DAR) systems can utilize optical waves, as in a light detection and ranging (LiDAR) system, or radio waves, as in a radio detection and ranging (RADAR) system. Some light detection and ranging (LiDAR) systems optimize various aspects of the LiDAR configuration based on different criteria. An optical wave is transmitted from an optical source to target object(s) at a given distance and the light backscattered from the target object(s) is collected. Some optical phased arrays (OPAs) used in such systems have a linear distribution of emitter elements (also called emitters or antennas). Steering about a first axis perpendicular to the linear distribution can be provided by changing the relative phase shifts in phase shifters feeding each of the emitter elements. Other techniques can be used for steering about a second axis orthogonal to the first axis. The optical source used in such a system is typically a laser, which provides an optical wave that has as narrow linewidth and has a peak wavelength that falls in a particular range (e.g., between about 100 nm to about 1 mm, or some subrange thereof), also referred to herein as simply “light.”

### SUMMARY

In one aspect, in general, an apparatus comprises: a transmitter module comprising: a first optical beam steering module, and timing circuitry configured to control timing of steering of the first optical beam steering module; and a receiver module comprising: a second optical beam steering module, and timing circuitry configured to control timing of steering of the second optical beam steering module; wherein timing of the steering of the first optical beam steering module and second optical beam steering module are controlled to include a delay based at least in part on a predetermined maximum target range.

Aspects can include one or more of the following features.

Each of the first optical beam steering module and the second optical beam steering module comprise a respective optical phased array.

Each optical phased array is formed by a plurality of antenna elements, where each antenna element of the plurality of antenna elements comprises a waveguide coupled to a phase shifter and a plurality of grating elements arranged along the waveguide.

Each of the first optical beam steering module and the second optical beam steering module is configured to steer an optical beam based on phase shifts applied to optical waves propagating in the waveguide.

The apparatus further comprises a first optical source configured to produce a first optical beam and a second optical source configured to produce a second optical beam.

The first optical beam has a first optical wavelength and the second optical beam has a second optical wavelength different from the first optical wavelength.

Control signals are applied to each of the first optical beam and the second optical beam.

The first optical beam steering module is configured to transmit at least a portion of the first optical beam at a transmit time that depends at least in part on the control signals applied to the first optical beam and transmit at least a portion of the second optical beam at a transmit time that depends at least in part on the control signals applied to the second optical beam.

The timing circuitry of the transmitter module is further configured to control a time duration that the first optical beam steering module is directed to a first angular position in a field of view and the timing circuitry of the receiver module is further configured to control a time duration that the second optical beam steering module is directed to the first angular position.

In another aspect, in general, a method comprises: steering a first optical beam steering module to transmit an optical beam to a first angular position of a target region at a first time; transmitting an optical beam to the first angular position of the target region using the first optical beam steering module; steering a second optical beam steering module to receive an optical beam from the target region at a second time; and receiving an optical beam from the target region using the second optical beam steering module; wherein a delay between the first time and the second time is based at least in part on a predetermined maximum target range.

Aspects can include one or more of the following features.

Each of the first optical beam steering module and the second optical beam steering module comprise a respective optical phased array.

Each optical phased array is formed by a plurality of antenna elements, where each antenna element of the plurality of antenna elements comprises a waveguide coupled to a phase shifter and a plurality of grating elements arranged along the waveguide.

The optical beam received from the target region comprises a portion of the optical beam transmitted to the target region.

The method further comprises: steering the first optical beam steering module to transmit an optical beam to a second angular position of the target region at a third time; transmitting an optical beam to the second angular position of the target region at a third time; steering a second optical beam steering module to receive an optical beam from the target region at a fourth time; and receiving an optical beam from the target region using the second optical beam steering module.

The first optical beam steering module transmits an optical beam to the first angular position over a first time period and transmits an optical beam to the second angular position over a second time period that is different from the first time period.

The optical beam transmitted to the first angular position has a first optical wavelength and second optical beam transmitted to the second angular position has a second optical wavelength different from the first optical wavelength.

The optical beam transmitted to the target region comprises a portion of an optical wave provided by a local oscillator.

The method further comprises applying a chirp to the portion of the optical wave provided by the local oscillator.

The method further comprises comparing the optical beam received from the target region with a portion of an optical wave provided by the local oscillator.

The method further comprises determining, based on a result of the comparing, a distance between the second optical beam steering module and the target region.

Aspects can have one or more of the following advantages.

In a DAR system, e.g., a light detection and ranging (LiDAR) system or radio detection and ranging (RADAR) system, a transmitted signal takes time to reach a target and return back to the system. In a LiDAR or RADAR system, the longest-range targets can have the most stringent link budgets due to the range equation. Additionally, the longest-range targets can incur the most time of flight. In a LiDAR/RADAR system with a coherent processing interval starting at the beginning of the transmitted signal, the longest-range target can incur the most time-of-flight loss. In some implementations, the system can be configured to offset a receiver in time such that the receiver is delayed in time behind the transmitter, to start the coherent processing interval at the instant the longest-range target would hit the receiver.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1C are schematic diagrams for time-of-flight recovery in an example DAR system.

FIG. 2 is a schematic diagram of an example of a LiDAR system.

FIG. 3A is a schematic diagram of an example of an optical phased array.

FIG. 3B is a schematic diagram of an example of an optical switched array.

FIG. 3C is a schematic diagram of an example of an optical switched array system.

FIG. 4 is a schematic diagram of an example of a grating-antenna-based optical phased array.

FIG. 5 is a schematic diagram of an example of angular steering associated with radiation intensity patterns for optical phased arrays.

FIG. 6 is a schematic diagram of an example LiDAR system.

FIG. 7A is a schematic diagram of an example LiDAR system.

FIG. 7B is a schematic diagram of an example timing protocol associated with a LiDAR system.

### DETAILED DESCRIPTION

Some DAR systems can be configured to recover information about a time of flight associated with a transmitted signal returning to the DAR system, i.e., as a return signal. In some examples, this processing can also be referred to as time-of-flight or ToF. In some examples, recovery of information about a time-of-flight of an optical wave can be performed using LiDAR systems such as coherent systems, e.g., frequency-modulated continuous wave (FMCW) systems.

In some examples, a DAR system can be configured to delay steering of a receiver (Rx) or receive aperture relative to a transmitter (Tx) or transmit aperture. One example method for delaying steering of a receiver relative to a transmitter is to use a phased array or a focal-plane-array approach, where both the transmitter and the receiver can be independently steered. A mechanical equivalent to this technique can comprise a galvo mirror where the transmit angle and the receive angle are pointed with a fixed tilted offset so that as the galvo mirror is rotating, the receive mirror is delayed by the same amount as the time-of-flight of a presumed longest-range target.

Some examples of FMCW systems can be configured to transmit or receive optical signals that change in frequency over time. Signals that change in frequency over time can be referred to as “chirped” signals. In some implementations, a transmitted signal can be chirped in time relative to a frequency of a local oscillator. A returning signal can then be compared with the local oscillator to determine a time-of-flight associated with the transmitted signal.

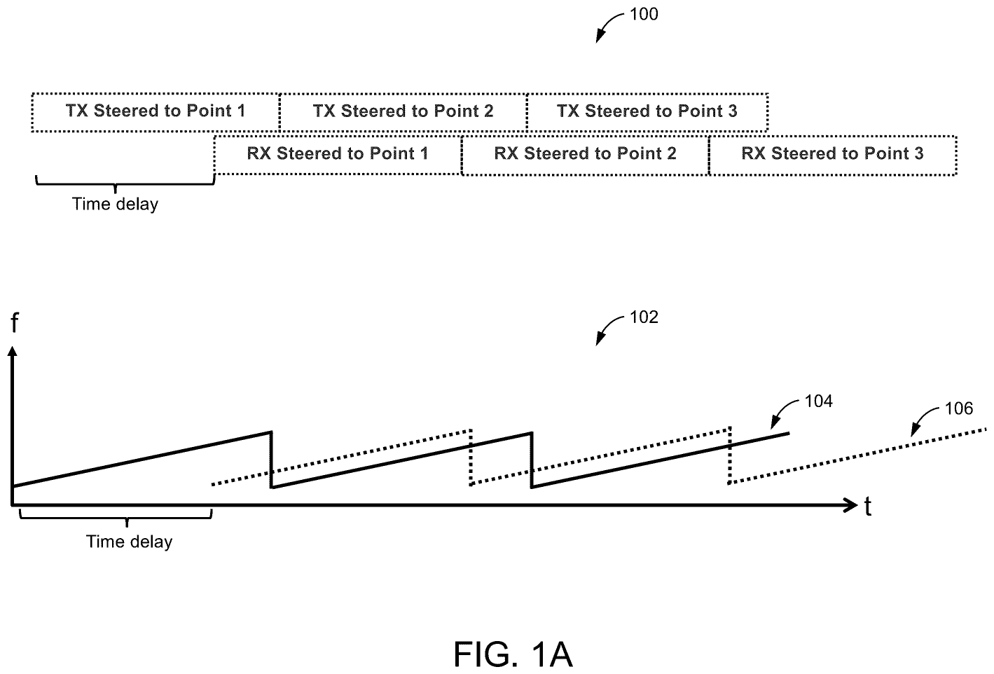

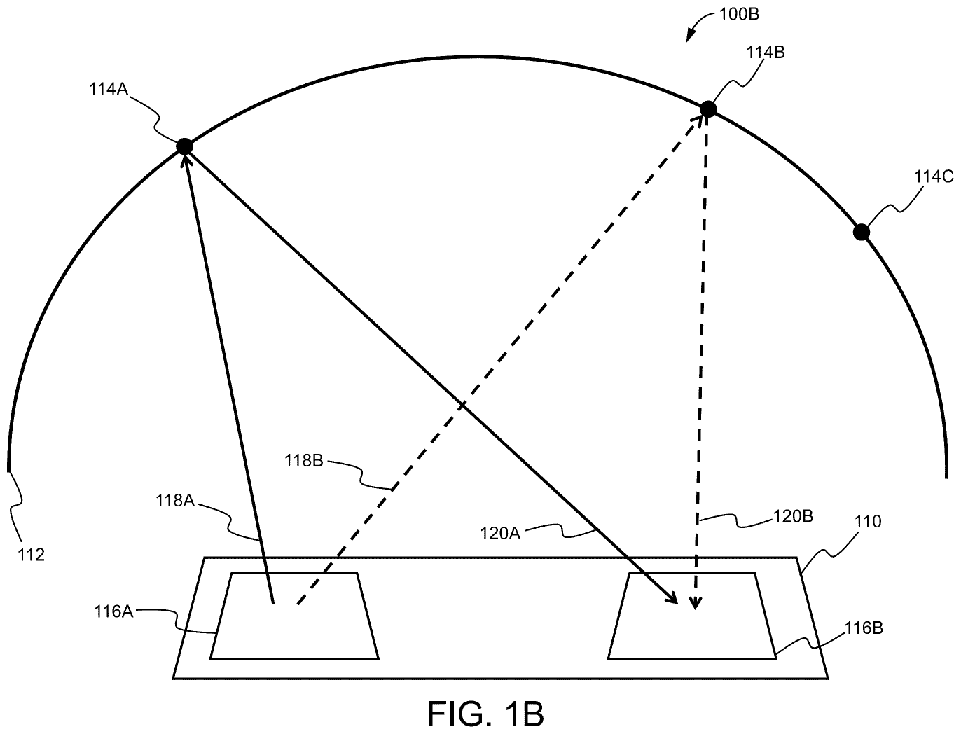

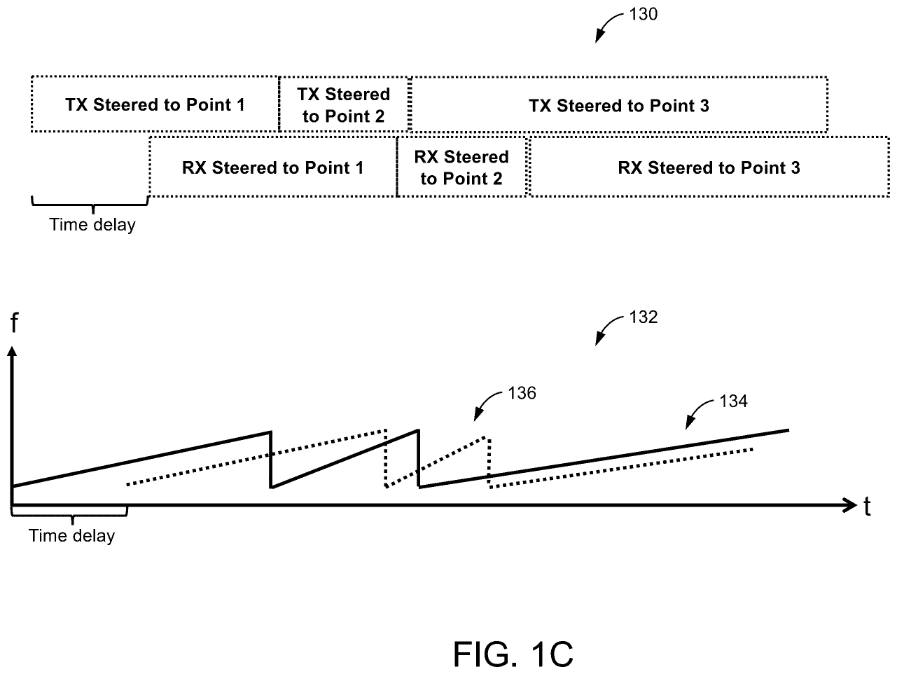

FIG. 1A shows an example timing diagram 100 and an example plot 102 of signals associated with a system, i.e., a DAR system. A system can be implemented in various configurations, including as a single apparatus or as a combination of one or more apparatuses that collectively perform the functions of a system. In some examples, the one or more apparatuses can form a device, i.e., a system-on-a-chip, or the one or more apparatuses can be separate devices. In this example system, the transmitted signals and received signals are offset by a time delay. In some implementations, the time delay can be based at least in part on a time-of-flight of optical or radio waves traveling to and from a furthest expected target region, i.e., a predetermined maximum target range. Beam steering modules of a transmitter (Tx) module, also referred to as a transmit aperture, steers to a new target in advance of steering beam steering modules of the receiver (Rx) module, also referred to as a receive aperture, to recover the time-of-flight loss for a furthest-range target. In some examples, each of the Tx module and the Rx module can steer a respective transmitted signal and received signal using an optical phased array (OPA). The transmitter module is steered to the first point and, after the time-of-flight to the presumed longest-range target has passed, the receiver module steers to the first point to catch the transmitted light. This interleaving of module steering can be associated with a reduced time-of-flight loss for the longest-range targets. The scheme can push the time-of-flight loss into a coherent processing interval (CPI) clipping loss for short-range-targets, but those short-range-targets can have higher signal-to-noise ratio (SNR) to compensate. In other words, a DAR system can be configured to “throw” a signal, i.e., an optical or radio wave, and then “catch” a returning optical or radio wave at a later time.

After the received signal has been captured, a time-of-flight recovery mechanism can be used. Some FMCW systems can mix optical waves of a local oscillator (LO) with a returning optical wave to determine information associated with the TOF of the optical waves, such as a distance or velocity of a system relative to a target region. Without using the methods disclosed herein, some FMCW systems can be associated with challenges such as a reset of an LO for a next frame while a system is receiving optical waves from a current frame. In contrast, using the methods disclosed herein, a time-division-multiplex method of switching between two different local oscillators can allow the next transmit frame to start while the previous receiver is still mixing. Yet another approach would have a Continuous-Wave (CW) LO, and the transmit chirp for FMCW is modulated post-LO.

Some DAR systems can be configured to “chirp” transmitted signals such that a transmitted signal increases or decreases in frequency over time. The plot 102 of signal frequency over time depicts example transmitted signals from a DAR system as a solid trace 104. As shown in the plot 102, each transmitted signal of the transmitted signals is “up-chirped” over time, i.e., a frequency of a transmitted signal increases over a duration of time. In some implementations, a transmitted signal can be “down-chirped” over time, i.e., a frequency of a transmitted signal decreases over a duration of time. In some implementations, a transmitted signal can be up-chirped and down-chirped such that the transmitted signal has a triangular frequency profile in time. In this example, the DAR system is configured to continuously transmit, or produce, signals continuously, as shown by the “steps” of the solid trace 104. A transmitted signal can then interact with a target region, i.e., by being back-scattered from one or more objects in a target region, to produce a return signal. The plot 102 further depicts example return signals associated with a detection and ranging system as a dashed trace 106. The solid trace 104 and the dashed trace 106 are offset in time by a time delay. In this example, the time delay is associated with a time-of-flight of optical or radio waves traveling to and from a furthest expected target region.

FIG. 1B depicts an example configuration 100B of a DAR system 110 interacting with a field-of-view 112. The field-of-view 112 comprises a plurality of points including a first point 114A, a second point 114B, and a third point 114C. In some examples, each of the plurality of points can also be referred to as “angular positions.” The DAR system 110 is configured to steer a first optical beam steering module 116A and a second optical beam steering module 116B to one or more points within the field-of-view 112. In some implementations, the DAR system 110 can be configured to steer each of the first optical beam steering module 116A and the second optical beam steering module 116B using a timing configuration as shown in FIG. 1A. By way of example, the DAR system 110 steers the first optical beam steering module 116A to the first point 114A of the field-of-view 112 at a first time. In this example, the first optical beam steering module 116A is configured to transmit an optical beam 118A to the first point 114A. The DAR system 110 is configured to steer the second optical beam steering module 116B to the first point 114A of the field-of-view 112 at a second time. In this example, the second optical beam steering module 116B receives an optical beam 120A from the first point 114A. A delay between the first time and the second time can be determined based at least in part on a predetermined maximum target range. The DAR system 110 is further configured to steer the first optical beam steering module 116A to the second point 114B of the field-of-view 112 at a third time. In this example, the first optical beam steering module 116A is configured to transmit an optical beam 118B to the second point 114B. The DAR system 110 is configured to steer the second optical beam steering module 116B to the second point 114B of the field-of-view 112 at a fourth time. In this example, the second optical beam steering module 116B receives an optical beam 120B from the second point 114B.

In some examples, an amount of time that an optical beam module spends at a point in a field-of-view can be referred to as a “dwell time” or “dwell.” Referring back to FIG. 1B, a dwell time associated with the first optical beam steering module 116A steering to the first point 114A can be different from a dwell time associated with the first optical beam steering module 116A steering to the second point 114B. Furthermore, a dwell time associated with the first optical beam steering module 116A steering to the first point 114A can be different from a dwell time associated with the second optical beam steering module 116B steering to the first point 114A.

An example timing diagram 130 associated with a DAR system is shown in FIG. 1C. In this example, a transmit aperture is steered to a first point and a receive aperture is steered to the first point after a time delay. The system is configured to “dwell” on the first point for a first period of time. The transmit aperture is then steered to a second point and the receive aperture is steered to the second point after the time delay. The system is configured to “dwell” on the second point for a second period of time. The transmit aperture is then steered to a third point and the receive aperture is steered to the third point after the time delay. The system is configured to “dwell” on the third point for a third period of time. An example plot 132 depicts a signal frequency over time for transmitted signals as a solid trace 134. The plot 132 further depicts example return signals as a dashed trace 136. The solid trace 134 and the dashed trace 136 are offset in time by the time delay.

In some examples, steering to different points, or angular positions, in a field of view can allow for a DAR system to detect objects in proximity to the system at varying ranges. In some examples, a DAR system can be configured to provide feedback to other systems or devices based on objects in proximity. By way of example, a DAR system can be a component of an autonomous vehicle system, which can prioritize a response based on ranges of objects.

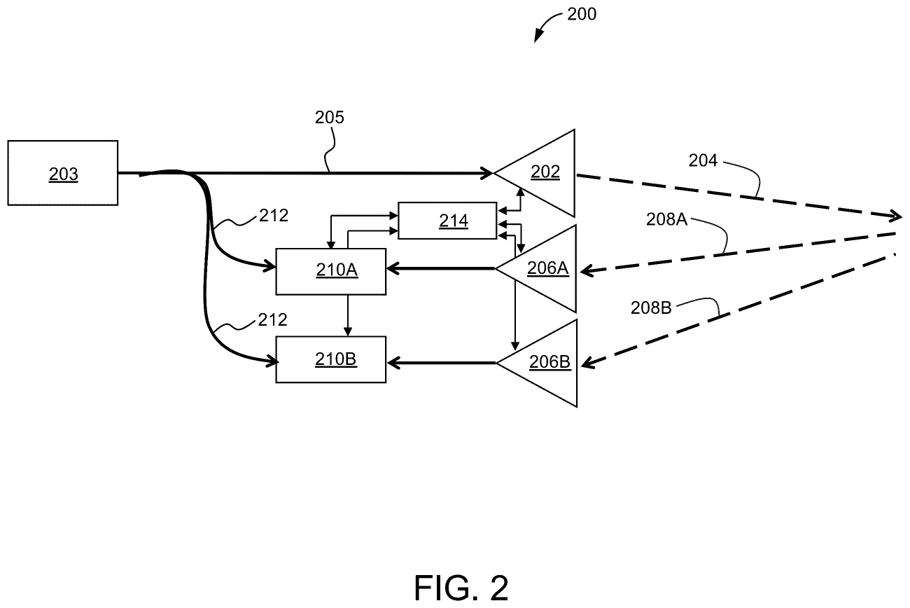

FIG. 2 shows an example of a system 200, i.e., a LiDAR system, in which some of the timing techniques shown in FIGS. 1A-1B can be used. The system 200 uses a configuration that can include one or more transmitter (Tx) antenna modules and one or more receiver (Rx) antenna modules. For example, some implementations are configured to use separate Tx and Rx antenna modules, where the separate antenna modules provide a separate transmitting aperture and receiving aperture (i.e., in a bistatic arrangement). In other implementations, an antenna module can be configured to operate in both a transmitter (Tx) mode of operation and a receiver (Rx) mode of operation (i.e., in a monostatic arrangement) where the transmitting aperture and the receiving aperture are the same. In the example of FIG. 2, the system 200 includes a transmitter antenna module 202 that transmits an optical beam 204 at an angle that can be steered over a steering range, and a first receiver antenna module 206A and a second receiver antenna module 206B that can each be controlled to receive light incoming from a particular angle (i.e., a multi-static arrangement). For example, the first receiver antenna module 206A can be configured to receiving incoming light 208A including a portion of the optical beam 204 backscattered from a target object or region, and the second receiver antenna module 206B can be configured to receive incoming light 208B including a portion of the optical beam 204 backscattered from the target.

The system includes an optical source 203 that provides an optical wave 205 to the transmitter antenna module 202. In some implementations, the optical source 203 is a continuous wave (CW) coherent light source (e.g., a laser) that provides an optical wave that has a narrow linewidth and low phase noise, for example, sufficient to provide a temporal coherence length that is long enough to perform coherent detection over the time scales of interest. In some implementations, the optical source 203 is a frequency tunable laser system in which the frequency of the light provided can be swept to perform frequency modulated continuous wave (FMCW) LiDAR measurements. Coherent receiver modules 210A and 210B receiving collected light from the first receiver antenna module 206A and the second receiver antenna module 206B, respectively, are configured to coherently mix the collected light with light of a local oscillator (LO) 212, which can be derived from the optical source 203 or from a portion of the optical wave 205 provided to the transmitter antenna module 202. A photodetection system, such as a balanced detector or an in-phase/quadrature-phase (IQ) detector, can be used to obtain one or more electrical signals representing the strength of a beat signal that has a maximum amplitude when the frequency of the LO and the received light are substantially equal.

A control module 214 is configured to control various aspects of the antenna modules and coherent receiver modules to determine information about a target object associated with a detection event based at least in part on one or more characteristics of the received backscattered light. In addition to a location of a target object that has backscattered light, there may also be range information characterizing a distance to the target object, and/or velocity information characterizing a relative speed of the target object, that can be obtained based at least in part on a frequency chirp (e.g., a linear chirp) that is applied to the optical wave 205 generated by the optical source 203. The control module 214 can include electronic circuitry (e.g., application specific integrated circuit, and/or processor cores), and in some cases is integrated on the same photonic integrated circuit including the antenna modules or on an electronic integrated circuit mounted to the photonic integrated circuit including the antenna modules.

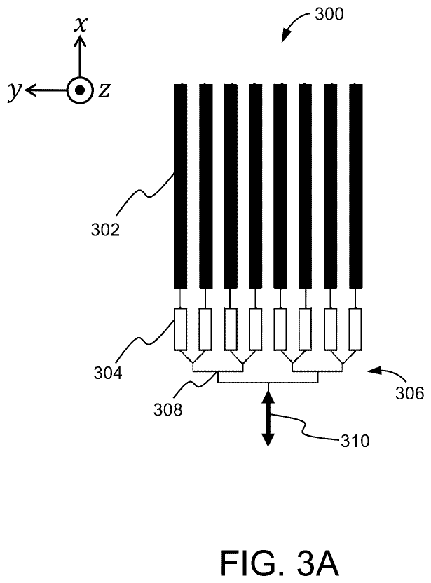

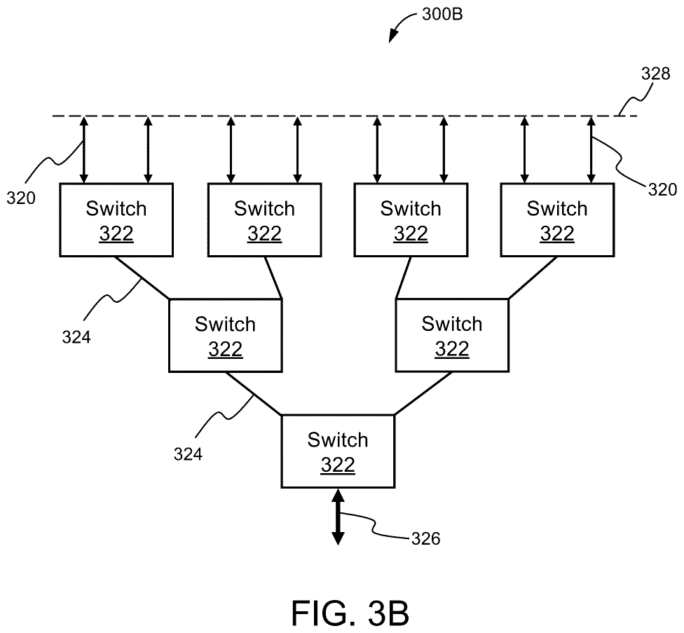

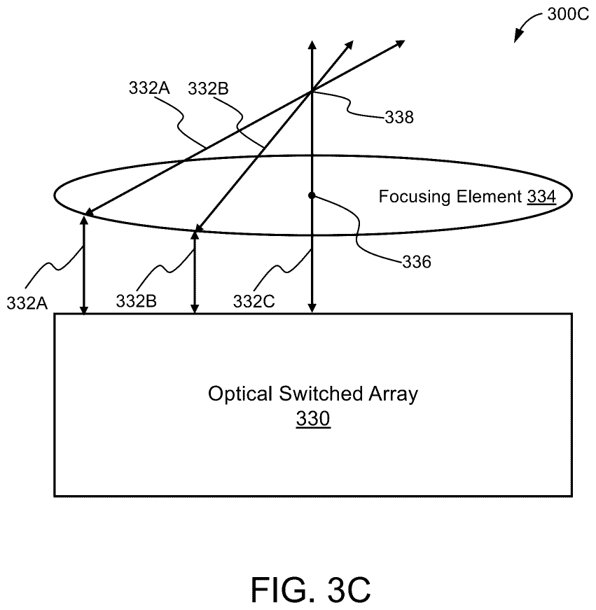

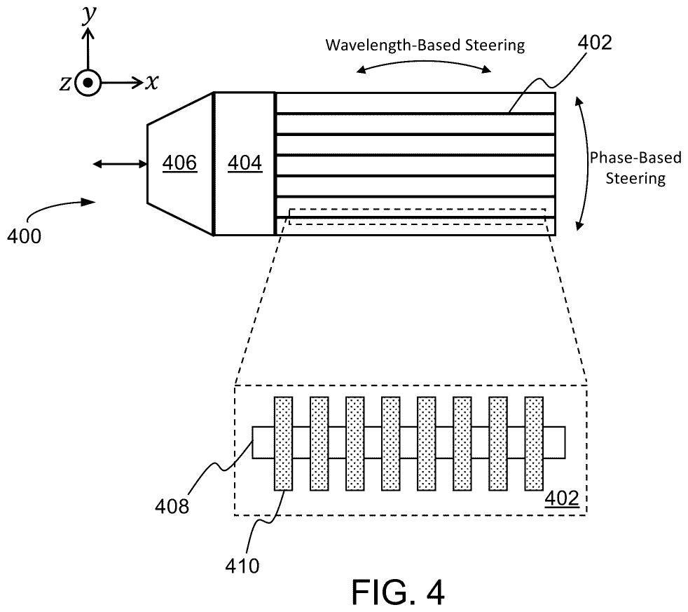

Any of a variety of techniques can be used to steer the transmission angle of the optical beam 204 provided by the transmitter antenna module 202 over a steering range, and to steer the reception angle of the first receiver antenna module 206A and the second receiver antenna module 206B. In some implementations, an OPA is used to enable steering of a lobe of a radiation intensity pattern (also referred to as a gain pattern) associated with the OPA. Some OPAs have a linear distribution of optical antennas. Steering about a first axis perpendicular to the linear distribution can be provided, for example, by changing the relative phase shifts in phase shifters coupled to each of the optical antennas. For example, FIG. 3A shows an example OPA 300 that includes an array of optical antennas 302. Light can be emitted from (and/or received into) optical antennas 302 from different emission planes depending on the type of optical antennas being used. For a grating-antenna-based OPA, each optical antenna is configured as an optical grating, as described in more detail in FIG. 4, and power from individual optical waves is emitted gradually over the length of the optical gratings over an emission plane in the plane of the page in FIG. 3A (the x-y plane). Alternatively, for an end-fire-antenna-based OPA, each optical antenna is configured to emit light from the ends of the optical antennas at an emission plane that is perpendicular to the plane of the page in FIG. 3A (the y-z plane). In either case, the optical waves optically interfere with each other starting at the emission plane to form an optical phased array output beam when the OPA 300 is used as a transmitter. The direction of peak constructive interference depends on the relative phase shifts imposed on light entering the optical antennas.

The OPA 300 includes an array of optical phase shifters 304 that impose respective phase shifts on optical waves provided as phase shifted optical waves entering the respective optical antennas 302 when the OPA is used as a transmitter, or on optical waves that have been collected by respective optical antennas 302 when the OPA is used as a receiver. The optical phase shifters 304 can be, for example, electro-optic, thermal, liquid crystal, pn junction phase shifters. In some examples, each of the optical phase shifters 304 is controlled independently, while in other examples two or more of the optical phase shifters 304 may be jointly controlled. An optical coupler 306 is configured to couple an optical port 310 to the array of optical phase shifters 304. In this example, the optical coupler 306 is in the form of a power splitting network formed form interconnected power splitters 308. In this example, the power splitters 308 are 1×2 power splitters (also referred to as 50/50 power splitters) and are interconnected by waveguides in a binary tree arrangement to achieve substantially equal power into each optical phase shifter 304 from an input optical wave entering the optical port 310 when the OPA 300 is used as a transmitter (Tx operation), and to provide substantially equal path lengths between each optical phase shifter 304 and the optical port 310. When the OPA 300 is used as a receiver (Rx operation), the light received by the optical antennas 302 and phase shifted by the optical phase shifters 304 is combined into an output optical wave at the optical port 310, which can then be further manipulated, transformed, or measured.

FIG. 3B shows an optical switched array 300B comprising an array of optical antennas 320 (e.g., waveguide facets in an end-fire configuration, optical gratings, plasmonic emitters, metal antennas, and mirror facets). The optical switched array 300B is arranged in a tree-like structure comprising a plurality of optical switches 322 optically interconnected via waveguides 324. In some examples, each optical switch of the plurality of optical switches 322 can be Mach-Zehnder interferometers or another kind of optical switch. Each optical switch of the plurality of optical switches 322 may be controlled in response to one or more applied voltages, allowing the plurality of optical switches 322 to direct light at a first switch port to a second switch port and a third switch port in a tunable ratio (e.g., 50/50, 0/100, 25/75). Accordingly, the plurality of optical switches 322 can be configured (e.g., by applied voltages) to open select optical pathways between an optical port 326 and the array of optical antennas 320. For example, by applying suitable (possibly time-varying) voltages, the optical switched array 300B can provide light (e.g., emitted from a laser) from the optical port 326 to one or more of the optical antennas 320. In another example, by applying suitable voltages, the optical switched array 300B can provide light received by one or more of the optical antennas 320 to the optical port 326. In an example that uses an end-fire configuration, light is transmitted from or received into the optical antennas 320 at facets distributed over an edge 328 along which the optical antennas 320 are arranged. In general, each optical switch of the plurality of optical switches 322 may have slightly different voltage requirements for power switching between their ports. Furthermore, one or more optical switches of the plurality of optical switches 322 may be electrically interconnected to allow for joint voltage control, possibly reducing the number of voltage sources used.

Referring again to FIG. 3B, each optical switch of the plurality of optical switches 322 are configured in a 1×2 (i.e., one port by two ports) arrangement, however, other arrangements (e.g., 1×3, 1×4, 2×2, or 2×3) and mixtures of arrangements may also be utilized. The one or more switch types in an optical switched array need not all be of the same type or of the same technology (e.g., thermo-optic or electro-optic switches). A portion or all of the optical switched array 300B may by formed as part of a PIC.

In some LiDAR system configurations, an external optical element such as a focusing element may be used to steer the light from the optical switched array system in one dimension. FIG. 3C shows an example optical switched array system 300C that performs 1D-beam-steering. The optical switched array system 300C comprises an optical switched array 330. The optical switched array 330 (e.g., the optical switched array 300B shown in FIG. 3B) can selectively output a first optical beam 332A, a second optical beam 332B, and/or a third optical beam 332C. While only three optical beams are shown in this example, some optical switched arrays can output a plurality of optical beams, each at a different respective spatial location. Each optical beam 332A-332C traverses a focusing element 334 (e.g., a lens) that converts a lateral displacement between the respective optical beams 332A-332C and a center 336 of the focusing element 334 into an angular displacement. In this example, each optical beam 332A-332C orthogonal to the surface of the focusing element 334 intersects at a point 338 (e.g., a focus of a lens). For example, the first optical beam 332A has a larger lateral displacement from the center 336 of the focusing element 334 than the second optical beam 332B, resulting in the first optical beam 332A having a larger angular displacement (with respect to its optical path prior to traversing the focusing element 334) than the second optical beam 332B. Since the third optical beam 332C is orthogonal to the surface of the focusing element 334 and has no lateral displacement from the center 336 of the focusing element 334, the third optical beam 332C has no angular displacement.

FIG. 4 shows an example of a grating-antenna-based OPA 400 that is configured for phase-based steering about the x axis and wavelength-based steering about the y axis. For example, when configured for Tx operation, optical waves propagate along optical grating antennas 402 (along the x axis), and light is perturbed and gradually emitted from various locations over the x-y emission plane. With this two-dimensional (2D) steering configuration, steering can be performed along transverse (e.g., polar and azimuth) angular directions in a polar coordinate system, with the steering in one angular direction being performed by phase shifters in a phase shifter (PS) module 404 and the steering in the other angular direction being performed by wavelength of an optical wave distributing optical power via an optical coupler 406. The adjustment of the transmission angle for the Tx operation and collection angle for the Rx operation in the phase-controlled angular direction can be dynamically performed as the phases imposed by the phase shifters in the PS module 404 can be quickly tuned. Each optical grating antenna 402 is formed from a waveguide 408 and grating elements 410 arranged periodically along the waveguide 408 with a particular pitch p1 (e.g., a constant spacing between grating elements 410) to perturb the guided optical wave causing emission in the direction of the grating elements 410. The angle at which the light is emitted from each optical grating antenna 402 depends on a relationship between the pitch p1 and the wavelength, and thus can be steered by changing the wavelength.

The PS module 404 can also be configured to provide focusing. For example, the emitted light can have a nonlinear phase front imposed on it by the phase shifters in the PS module 404 for focusing in Tx operation. This dynamically adjusted phase front can also tune the focal depth for Rx operation. Other techniques can be used for steering about a second axis orthogonal to the phase-based steering axis (e.g., mechanical based steering), such as when wavelength-based steering is not used for an optical grating antenna, or when an end-fire optical antenna is used.

In some implementations, an OPA can be used as an optical beam steering module such that an optical beam can be steered to angular positions within a field-of-view by controlling the phase shifters and optical beam wavelength. In some implementations, using an OPA in this way can allow a beam steering module to be precisely steered to discrete positions at discrete points in time.

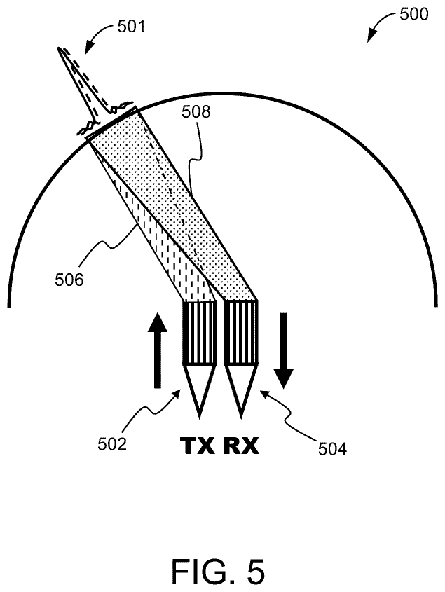

FIG. 5 shows an example LiDAR system 500 producing radiation intensity patterns 501 associated with a transmitter OPA 502 and a receiver OPA 504. In this example, main lobes associated with a transmitter radiation pattern 506 and a receiver radiation pattern 508 overlap. Such an arrangement of main lobe overlap can result, for example, from tuning phase shifters associated with transmitter and receiver optical antennas in the respective OPAs. Backscattered light from a target object situated near the main lobes is received by the receiver OPA 504. In each radiation intensity pattern, there may be a main lobe and additional grating lobes that occur on each side of the main lobe due to the limit in how close adjacent optical antennas can be in an OPA, which may limit the phase-based angular tuning range.

In some implementations, the examples described herein may be designed to operate over a predetermined range of optical wavelengths such as, for example, the λ=1500 to 1600 nm band or the λ=1270 to 1330 nm band, and the pitch p corresponding to a distance between adjacent optical antennas may be of similar magnitude to the optical wavelength to increase the spacing between grating lobes (and thereby increase tuning range), or in some cases less than half of the optical wavelength to avoid grating lobes. For example, for operation in the 1500 to 1600 nm band, 700 nm≤p≤4000 nm may be typical.

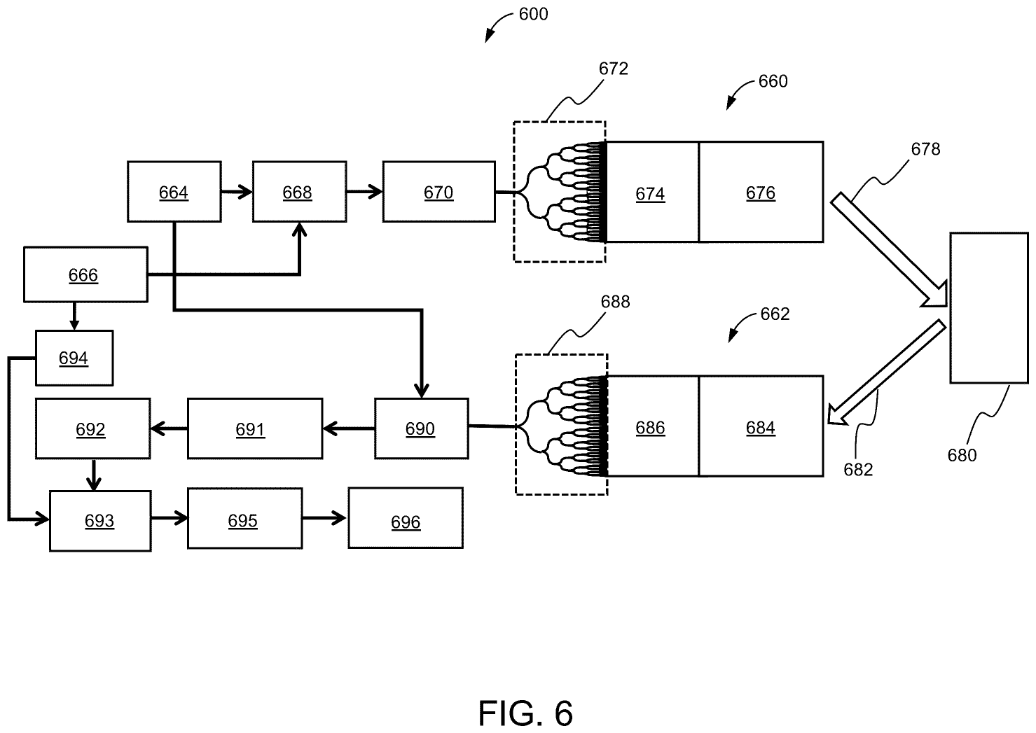

Some systems can be configured to process the return signal arriving at a receiver. FIG. 6 depicts an example system 600, i.e., a LiDAR system, configured for processing return signals. In some implementations, the system 600 can be configured such that the signals transmitted from and received at the system 600 are offset in time, as shown in FIG. 1A. The system 600 comprises a transmit aperture 660 and a receive aperture 662. Chirp is applied to a portion of optical waves produced by a laser module 664 configured as a continuous wave LO using an RF optical modulator 666. In this example, a chirp signal from the RF optical modulator 666 drives an optical single sideband (SSB) modulator 668, which modulates the optical waves from the laser module 664. The output of the SSB modulator 668 is directed to a first booster 670. The output of the first booster 670 is directed to a splitting network 672 and phase shifters 674 before traveling to optical antennas 676 of the transmit aperture 660. The optical antennas 676 of the transmit aperture 660 produce an optical beam 678, which travels to a target region 680. In some examples, the target region 680 can comprise one or more objects that backscatter a portion of the optical beam 678 as an optical beam 682. Optical antennas 684 of the receive aperture 662 receive the optical beam 682. The optical antennas 684 are connected to phase shifters 686 and a splitting network 688. The output of the splitting network 688 is directed to an IQ demodulator 690, which also receives a portion of an optical wave from the laser module 664. An amplifier 691 receives the output from the IQ demodulator 690 and a digitizer 692 is used to convert the signal from the amplifier 691 into a digital signal. A mixer module 693 mixes the digital signal from the digitizer 692 and a signal from the RF optical modulator 666 that is time delayed by a time delay module 694. In other words, the received and digitized signal is mixed in the digital domain with a time-delayed version of the chirp signal. Circuitry is then configured to perform operations on the output of the mixer module 693. In this implementation, the circuitry comprises a processor 695 configured to perform fast Fourier transform (FFT) of the output from the mixer module 693 and a processor 696 that is configured to perform constant false alarm rate (CFAR) processing.

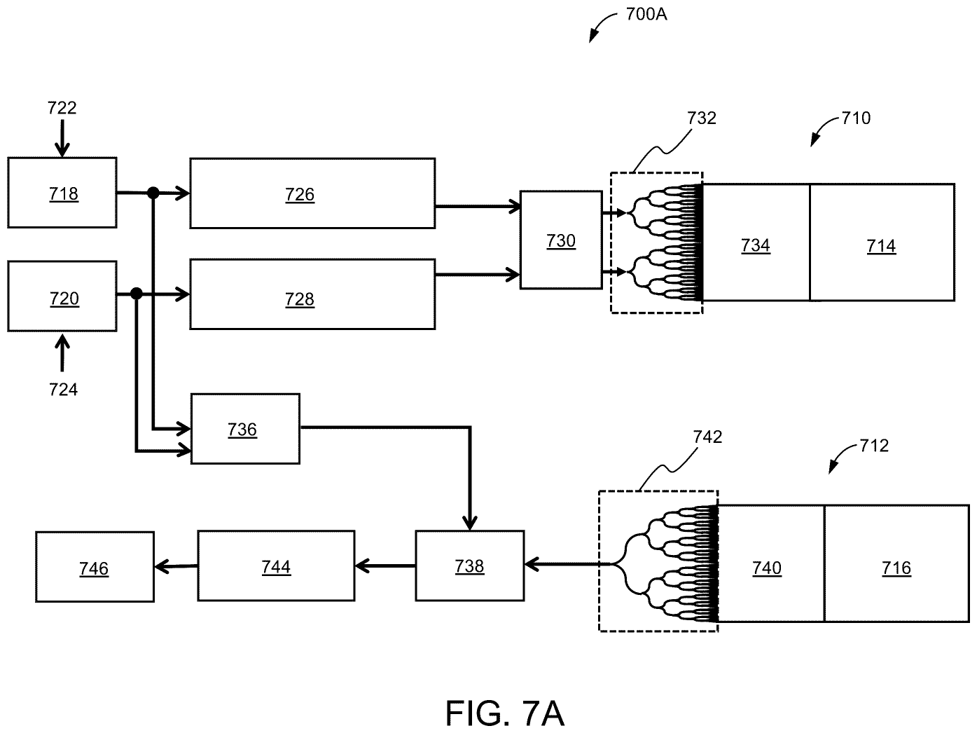

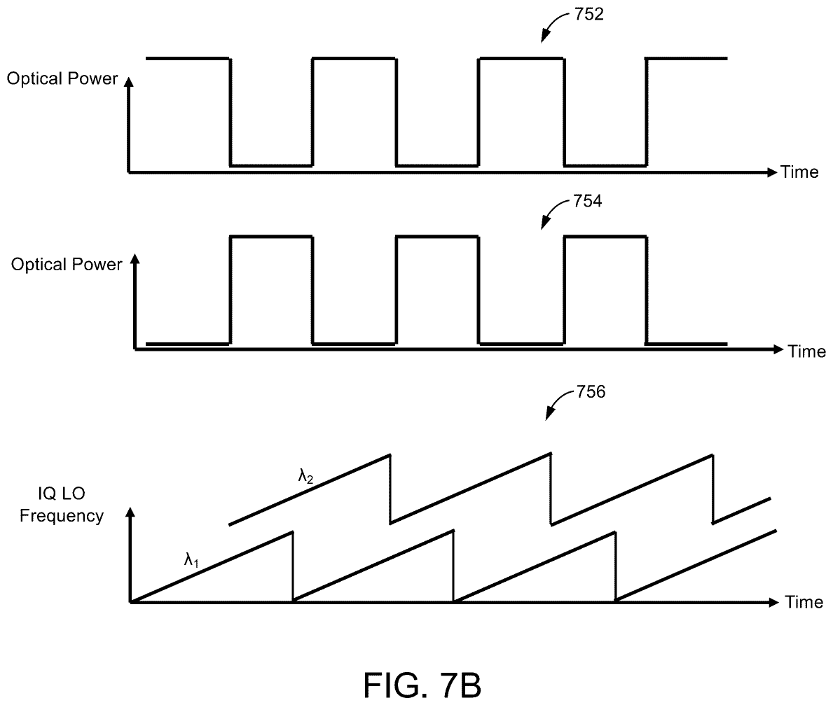

As previously mentioned, some systems can switch between two different local oscillators to process return signals. An example LiDAR system 700A comprising OPAs is shown in FIG. 7A. The LiDAR system 700A is configured for time-of-flight recovery with time domain multiplexing and LO switching, also referred to as LO down-mixing. The LiDAR system 700A comprises a transmit module 710 and a receive module 712, each comprising a plurality of optical antennas 714 and a plurality of optical antennas 716. A first seed laser 718 and a second seed laser 720 are independently chirped, respectively, by a control signal 722 and a control signal 724. Examples of control signals are depicted in FIG. 7B. The first seed laser 718 is configured to output optical waves having a wavelength λ₁ while the second seed laser 720 is configured to output optical waves having a wavelength λ₂. In some examples, λ₁ can be different from λ₂. Respective outputs from each of the first seed laser 718 and the second seed laser 720 are split into respective first portions and second portions. The first portions of each of the outputs are directed to a booster amplifier 726 and a booster amplifier 728, respectively. In some implementations, i.e., a time-domain-multiplexed approach, only one of the booster amplifier 726 or the booster amplifier 728 can be active at a time. Outputs from each of the booster amplifier 726 and the booster amplifier 728 are directed into a splitting module 730 configured as a 2 port×2 port module. The output of the splitting module 730 is directed to a splitting network 732 and phase shifters 734 before traveling to the plurality of optical antennas 714 of the transmit module 710. The second portions of the outputs are directed into a switching module 736 with an output directed to a demodulator 738. In some examples, the demodulator 738 can be configured as an in-phase/quadrature-phase demodulator. The demodulator 738 receives optical signals from the plurality of optical antennas 716 of the receive module 712 by way of phase shifters 740 and a splitting network 742. Circuitry is configured to receive signals from the demodulator 738. In this example, the circuitry comprises an amplifier and digitizer 744 and constant false alarm rate (CFAR) detector 746.

FIG. 7B depicts an example timing diagram 752, an example timing diagram 754, and an example timing diagram 756 associated with the LiDAR system 700A. The timing diagram 752 depicts the optical power of the booster amplifier 726, i.e., the optical power of λ₁, over time. The timing diagram 754 depicts the optical power of the booster amplifier 728, i.e., the optical power of λ₂, over time. The timing diagram 756 depicts the IQ LO frequency of optical waves associated with λ₁ and λ₂ over time.

As shown in the timing diagram 756 in FIG. 7B, the seed laser can continue chirping even after the booster has been deactivated. With this configuration, the seed laser can be switched to the in-phase/quadrature-phase (IQ) demodulator for receiving the signal. An advantage of this system is that FMCW processing can be used.

In some examples, using multiple frequencies, as shown in FIGS. 7A-7B, a transmitter can transmit optical signals at a first frequency and a second frequency such that a receiver can receive optical signals at the first frequency and signals at the second frequency. This configuration can allow for multiplexing, as signals having the first frequency and the second frequency can be processed simultaneously. This configuration can be associated with reduced loss of signals returning from a close target.

Some systems can comprise analog, digital, or mixed-signal circuitry configured to perform functions such as signal processing, voltage regulation, or data acquisition. Some systems can comprise interface or control circuitry configured to perform functions such as applying bias voltages, measuring voltages, or interfacing with components of the circuit. In some examples, control circuitry can be implemented in one or more dedicated regions of an IC, or distributed throughout a circuit architecture. In some examples, control circuitry can comprise components such as a field-programmable gate array (FPGA), an application specific integrated circuit (ASIC), one or more processors or processor cores, including central processing unit(s) (CPU(s)) and/or graphics processing unit(s) (GPU(s)), or other computing devices or modules capable of executing a program (e.g., software and/or firmware) comprising instructions or other compiled or executable code. The electronic circuitry can also include at least one data storage system (e.g., including volatile and non-volatile memory, and/or storage media). The program may be provided on a computer-readable storage medium, or delivered over a communication medium such as a wired or wireless network, to a device module where it can be stored and eventually executed when read by the device to perform the procedures of the program.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
a transmitter module comprising:
a first optical beam steering module, and
timing circuitry configured to control timing of steering of the first optical beam steering module; and
a receiver module comprising:
a second optical beam steering module, and
timing circuitry configured to control timing of steering of the second optical beam steering module;
wherein timing of the steering of the first optical beam steering module and second optical beam steering module are controlled to include a delay based at least in part on a predetermined maximum target range.

2. The apparatus of claim 1, wherein each of the first optical beam steering module and the second optical beam steering module comprise a respective optical phased array.

3. The apparatus of claim 2, wherein each optical phased array is formed by a plurality of antenna elements, where each antenna element of the plurality of antenna elements comprises a waveguide coupled to a phase shifter and a plurality of grating elements arranged along the waveguide.

4. The apparatus of claim 3, wherein each of the first optical beam steering module and the second optical beam steering module is configured to steer an optical beam based on phase shifts applied to optical waves propagating in the waveguide.

5. The apparatus of claim 1, further comprising a first optical source configured to produce a first optical beam and a second optical source configured to produce a second optical beam.

6. The apparatus of claim 5, wherein the first optical beam has a first optical wavelength and the second optical beam has a second optical wavelength different from the first optical wavelength.

7. The apparatus of claim 5, wherein control signals are applied to each of the first optical beam and the second optical beam.

8. The apparatus of claim 7, wherein the first optical beam steering module is configured to transmit at least a portion of the first optical beam at a transmit time that depends at least in part on the control signals applied to the first optical beam and transmit at least a portion of the second optical beam at a transmit time that depends at least in part on the control signals applied to the second optical beam.

9. The apparatus of claim 1, wherein the timing circuitry of the transmitter module is further configured to control a time duration that the first optical beam steering module is directed to a first angular position in a field of view and the timing circuitry of the receiver module is further configured to control a time duration that the second optical beam steering module is directed to the first angular position.

10. A method comprising:
steering a first optical beam steering module to transmit an optical beam to a first angular position of a target region at a first time;
transmitting an optical beam to the first angular position of the target region using the first optical beam steering module;
steering a second optical beam steering module to receive an optical beam from the target region at a second time; and
receiving an optical beam from the target region using the second optical beam steering module;
wherein a delay between the first time and the second time is based at least in part on a predetermined maximum target range.

11. The method of claim 10, wherein each of the first optical beam steering module and the second optical beam steering module comprise a respective optical phased array.

12. The method of claim 11, wherein each optical phased array is formed by a plurality of antenna elements, where each antenna element of the plurality of antenna elements comprises a waveguide coupled to a phase shifter and a plurality of grating elements arranged along the waveguide.

13. The method of claim 10, wherein the optical beam received from the target region comprises a portion of the optical beam transmitted to the target region.

14. The method of claim 10, further comprising:
steering the first optical beam steering module to transmit an optical beam to a second angular position of the target region at a third time;
transmitting an optical beam to the second angular position of the target region at a third time;
steering a second optical beam steering module to receive an optical beam from the target region at a fourth time; and
receiving an optical beam from the target region using the second optical beam steering module.

15. The method of claim 14, wherein the first optical beam steering module transmits an optical beam to the first angular position over a first time period and transmits an optical beam to the second angular position over a second time period that is different from the first time period.

16. The method of claim 14, wherein the optical beam transmitted to the first angular position has a first optical wavelength and second optical beam transmitted to the second angular position has a second optical wavelength different from the first optical wavelength.

17. The method of claim 10, wherein the optical beam transmitted to the target region comprises a portion of an optical wave provided by a local oscillator.

18. The method of claim 17, further comprising applying a chirp to the portion of the optical wave provided by the local oscillator.

19. The method of claim 17, further comprising comparing the optical beam received from the target region with a portion of an optical wave provided by the local oscillator.

20. The method of claim 19, further comprising determining, based on a result of the comparing, a distance between the second optical beam steering module and the target region.
